(19) United States
(12) Patent Application Publication
(10) Pub. No.: US 2008/0062455 A1
(43) Pub. Date: Mar. 13, 2008

(54) Method for Transmitting Real Time Image Data of Wireless Communication System

(75) Inventor: Feng-Huan Kang, Taipei Hsien (TW)

Correspondence Address: WPAT, PC;INTELLECTUAL PROPERTY ATTORNEYS, 2030 MAIN STREET, SUITE 1300, IRVINE, CA, 92614, US

(73) Assignee: CHENG UEI PRECISION INDUSTRY CO., LTD., Taipei Hsien (TW)

(21) Appl. No.: 11/530,820

(22) Filed: Sep. 11, 2006

(51) Int. Cl. G06F 3/12

(52) U.S. Cl. 358/1.15

(57) ABSTRACT

The communication system comprises an image module and a host. The host initializes and controls the image module by sending control commands thereto and each control command comprises a plurality of sub-commands. The sub-commands are transmitted to the image module in sequence. Then, the image module processes the sub-command and returns an ACK to the host. When completely sends all sub-commands of a control command out, the host checks the feed-back ACKs, if the feed-back ACKs are fault, then resends the sub-commands of the control command in sequence. Therefore, the host no longer wastes time on waiting an ACK before sending another sub-command. As a result, it cuts delay down and improves transmitting efficiency of the wireless communication system.

### BACKGROUND OF THE INVENTION

1. Field of the Invention

The present invention relates to a wireless communication system, more particularly, relates to a method for transmitting real time image data of wireless communication system.

2. The Related Art

Nowadays, real-time image data transmitting technology is widely deployed, such as the real time image data transmitted from a camera to a host (e.g., a computer, a PDA or a portable phone), then the host further processes the image data received and display it on its monitor immediately. Since the real-time image data is massive and should be delivered in time with small delay as possible, the real-time image data is better to be transmitted via physical cable connection in a conventional way.

Please refer to FIG. 1, a conventional Bluetooth wired communication system for transmitting image data in real time generally includes a host 1 and an image module 2. The host 1 and the image module 2 make physical connection for transmitting image data in a conventional way.

The host 1 is an electronic device used for receiving image data and display the image on its monitor, such as a computer or a mobile phone.

The image module 2, such as a digital camera, converts the light received into electronic signals, which are digitized and stored as digital image data. The digital image data may be stored in an electronic memory system, such as random access memory (RAM). Alternatively, the digital image data may be stored on a magnetic or optical disk of the type commonly used to store digital data. Generally, the image module 2 includes a lens, an image sensor (e.g. CCD, CMOS, etc.), an ADC (Analog-to-Digital Converter), a DSP (Digital Signal processor) and a RAM.

The image module 2 is configured without external flash memory for cost down issue. Therefore, the image module 2 cannot keep the parameters when it is powered off. As a result, the image module 2 has to be initialized at startup process by an extra control program which installed in the host 1. That is, the host 1 stores and runs the control program to set a lot of parameters (e.g. resolution, saturation, masks, enable/disable global interrupt and lens shading compensation) to the image module 2. Therefore, the initialized image module 2 can be further controlled by the host 1 to capture image and send image data to the host 1.

Now refer to FIG. 2, as mentioned above, the control program which stored and run in the host 1 includes the following steps: in step S1, the control program firstly initializes the DSP (digital signal processor) by setting parameters thereto. Further in step S2, the sensor is activated by corresponding parameters. In steps S3 and S4, The control program further controls the initialized image module 2 to capture image and send image data to the host 1 over and over again. In fact, the image module 2 stores the image data in the RAM temporarily, then sends the image data to the host 1. The continuing image data transmitted from the image module 2 to the host 1 forms a stream media and the image data will be processed in the host 1 and display on a monitor of the host 1.

Please refer to FIG. 3, the host 1 runs the control program to initialize and control the image module 2 by sending control commands thereto. The host 1 can receive proper image data when the control commands are correctly implemented by the image module 2. Exactly, each control command includes a plurality of sub-commands 11 and each sub-command 11 is a data block transmitted by a data packet. The plurality of sub-commands 11 cooperates to set address and data to a register of the image module 2 for implementing a control command. The quantity of sub-commands 11 of the control command is decided by the communication protocol between the host 1 and the image module 2. For example, the quantity of the sub-commands 11 of each control command may be four, the first one is a set register request which means beginning to set value to the register of the image module 2; the second one sets address to the register; the third one set data to the register; and the last one is a acknowledgement sent from the host 1 to the image module 2 which means the sub-commands 11 of the a control command transmitted completed. Please refer to FIG. 3. The host 1 sends sub-commands 11 of a control command in sequence and the image module 2 feeds back a corresponding ACK (acknowledgement) 21 to the host 1 after implementing a sub-command 11; in another hand, the host 1 receives and checks the feed-back ACK 21, if the ACK 21 is faultless, then, continues to next sub-command 11 for implementing a control command, or else, resends the preceding sub-command 11.

Bluetooth is an emerging wireless communication standard for short-distance defined by a standardization group called the Bluetooth Special Interest Group (Bluetooth SIG), operating in the 2.4 GHz ISM band world-wide according to available existing specifications known in the art. It is convenient to establish a wireless connection between electronic devices using Bluetooth technology. Bluetooth SPP (Serial Port Profile) is a basic profile, it defines how to set up virtual serial ports on two devices and connecting these with Bluetooth. Using this profile provides Bluetooth units with an emulation of a serial cable using RS232 control signaling (RS232 is a common interface standard for data communication equipment, it is the standard utilization on the serial port in the PC industry).

Transmitting real-time image data via the Bluetooth SPP wireless connection is flexible and cost-effective, but each data packet will delay more than transmitted via physical connection. For example, data packet transmitted via Bluetooth SPP wireless communication technology will delay 20 ms under baud rate 921.6 Kbps. As a result, when using Bluetooth SPP wireless communication technology in place of physical connection to transmit real-time image data in the communication system which mentioned above, sending a sub-command 11 and receiving an corresponding ACK 21 will roughly cost 40 ms. Accordingly, successfully transmitting a control command which includes four sub-commands 11 will cost about 160 ms. The host 1 sets a lot of parameters (e.g. resolution, saturation, masks, enable/disable global interrupt and lens shading compensation, etc.) to initialize the image module 2 at the startup process of the image module 2 by sending massive control commands thereto. Further the host 1 controls the image module 2 to capture image and send image data by continuing sending corresponding control commands to the image module 2 over and over again. For example, at the startup process of the image module 2, the massive parameter set to the image module 2 may need more than one thousand sub-commands 11, moreover, at normal working state of the Bluetooth wireless communication system, the host 1 sends control commands to the image module 2 over and over again. Therefore, too much delay caused by transmitting the control commands leads to a low transmitting efficiency, and unable to satisfy the customer.

### SUMMARY OF THE INVENTION

An object of the present invention is to provide a method for transmitting real time image data of a wireless communication system with higher efficiency.

The communication system comprises a Bluetooth-enabled image module and a Bluetooth enabled host. The host initializes and controls the image module by sending control commands thereto. Each control command comprises a plurality of sub-commands.

The sub-commands are transmitted to the image module in sequence. Then, the image module processes the sub-command and returns a corresponding ACK to the host. When completely sends all sub-commands of a control command out, the host checks the feed-back ACKs, if the feed-back ACKs are fault, then resends the sub-commands of the control command in sequence.

The host no longer wastes time on waiting an ACK before sending another sub-command. As a result, it cuts delay down and improves transmitting efficiency of the wireless communication system.

These and other features, objects and advantages of the present invention will be more fully apparent from the following detailed description set forth below when taken in conjunction with the accompanying drawings.

### BRIEF DESCRIPTION OF THE DRAWINGS

FIG. 1 illustrates a communication system for transmitting image data in real time via physical connection in prior art;

FIG. 2 is a flowchart showing a control program for the image module in prior art;

FIG. 3 is a flow diagram showing the transmitting process of a control command in prior art;

FIG. 4 is illustrates a communication system for transmitting image data in real time via Bluetooth SPP wireless connection; and

FIG. 5 is a flow diagram showing the transmitting process of a control command according to the present invention.

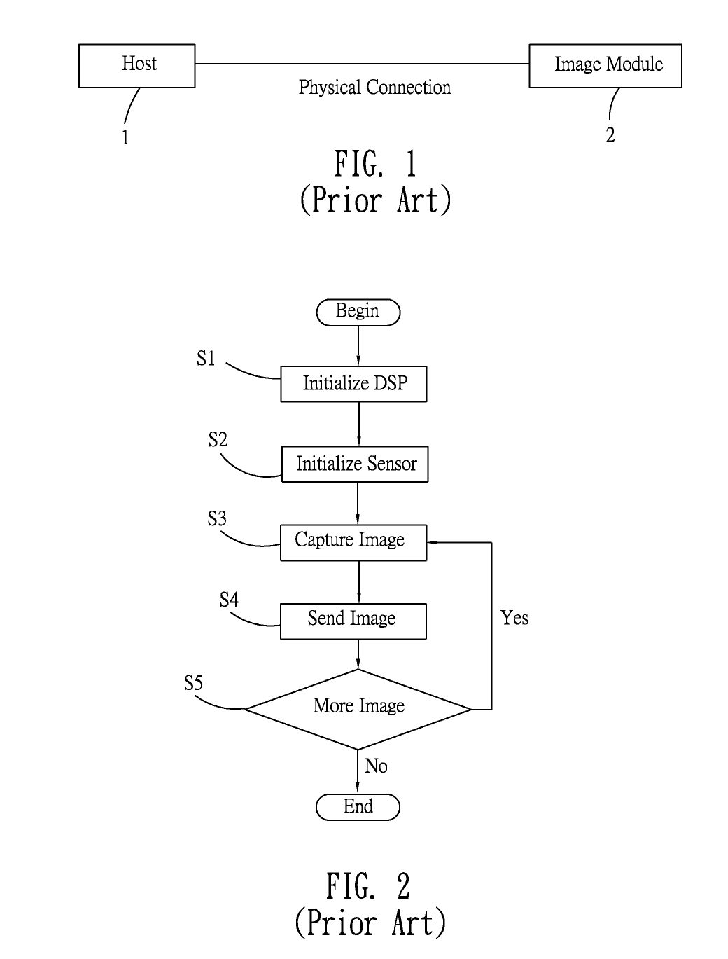

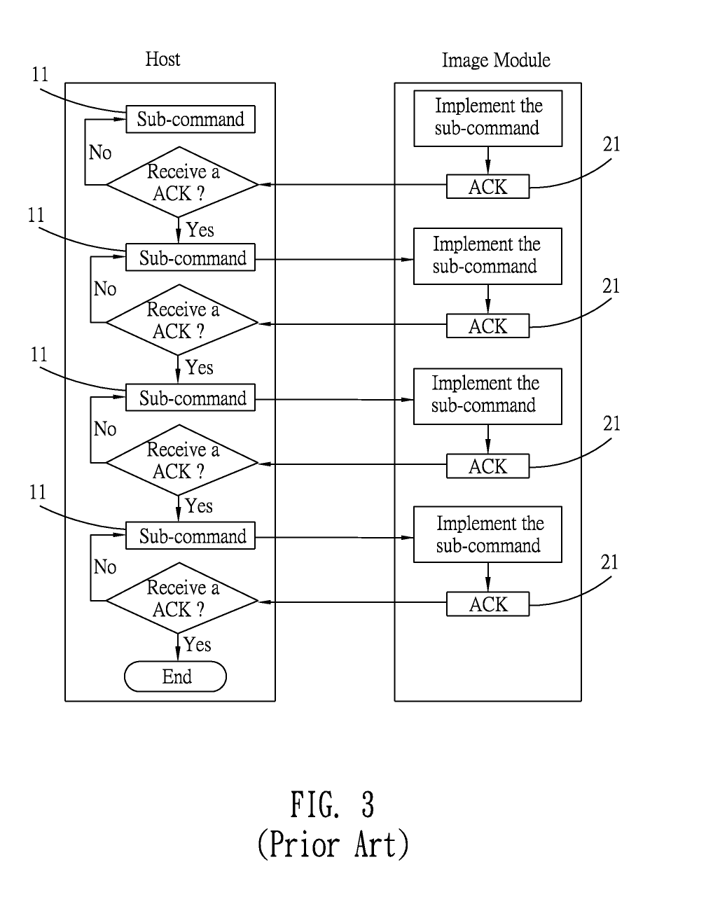

### DETAILED DESCRIPTION OF THE PREFERRED EMBODIMENT

The nature, objectives, and advantages of the invention will become more apparent to those skilled in the art after considering the following detailed description in connection with the accompanying drawings.

Although the invention is described with respect to specific embodiments, the principles of the invention as defined by the claims appended herein may be applied beyond the embodiments of the description described specifically herein. Moreover, certain details have been omitted to avoid obscuring the inventive aspects of the invention. The specific details not described in the present application are within the knowledge of a person of ordinary skill in the art, having the benefit of this disclosure.

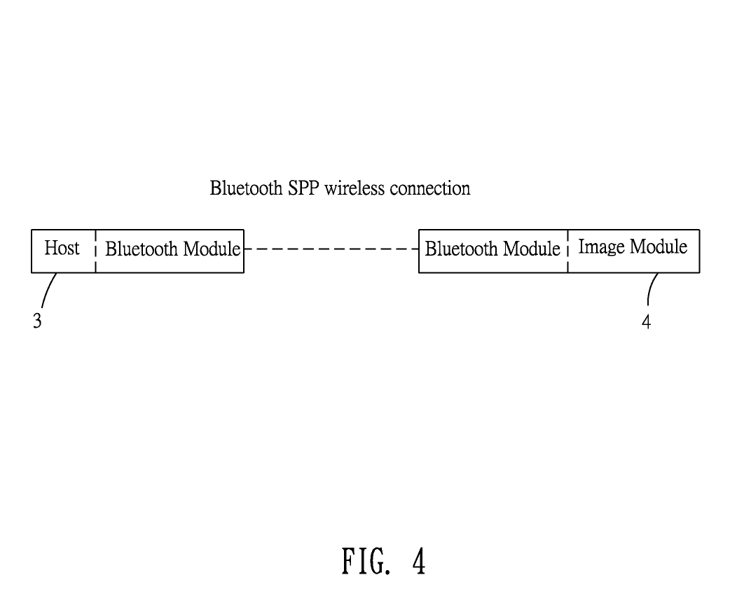

Referring to FIG. 4, a Bluetooth wireless communication system for transmitting image data in real time according to the present invention includes a Bluetooth-enabled host 3 and a Bluetooth-enabled image module 4. The host 3 and image module 4 makes wireless communication with Bluetooth SPP technology in a conventional way.

In order to make wireless connection with Bluetooth SPP technology, both sides of the communication system should be configured with a Bluetooth module. For example, if the host 3 is a computer, the host 3 can be configured with a Bluetooth USB dongle. Conveniently, if the computer is running WINDOWS XP operating system with SP2 (Service Pack 2) or higher version, the Bluetooth driver program is a built-in function, no drivers required or needed for complex installation. Alternatively, the user can still install the driver program provided by the Bluetooth dongle supplier manually no matter the Bluetooth driver is implemented or not. In another hand, the image module 4 should be configured with Bluetooth module. Preferably, the Bluetooth module is integrated with the image module 4.

As mentioned hereinbefore, the image module 4 is configured without external flash memory for cost down issue, therefore, the image module 4 has to be initialized by an extra control program which stored and run in the host 3. The host 3 set parameters to the image module 4 at the initialization process of the image module 4 by sending control command thereto via Bluetooth SPP wireless connection. The control program is integrated with the driver program of the image module 4 installed in the host 3.

The image module 4 is a slave device of the host 3. The host 3 controls the initialized image module 4 to capture image and send image to the host 3 by sending control commands thereto.

At a normal working state of the Bluetooth wireless communication system, the host 3 firstly sends a control command to command the image module 4 to capture image, and then, sends another control command to command the image module 4 to send image data to the host 3. The host 3 can receive proper image data when the control commands are correctly implemented by the image module 4, or else, if a preceding control command fails, the following control command may fail too. For instance, the host 3 firstly commands the image module 4 to capture image, as the capture-image control command has not been properly implemented, the host 3 continues to command the image module 4 to send image data, and that will lead to an error. The image module 4 capture image and send image data to the host 3 over and over again. Meanwhile, the host 3 further processes the image data received and display it on a monitor.

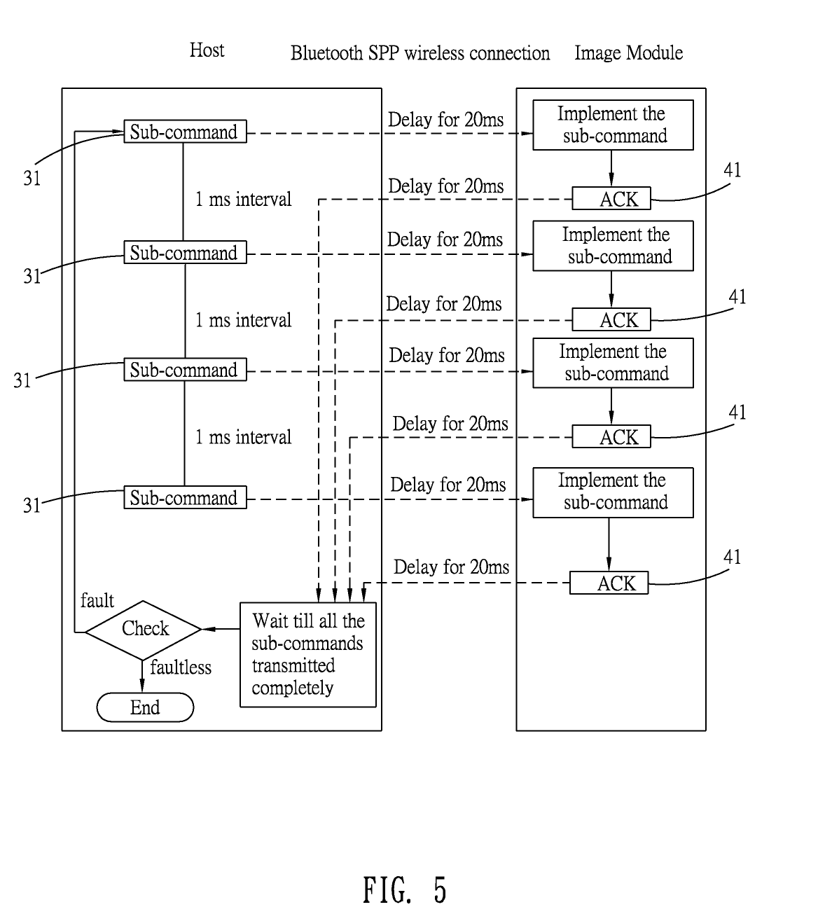

Now refer to FIG. 5, the control command which sent from the host 3 to the image module 4 includes a plurality of sub-commands 31. In the present embodiment, each control command includes four sub-commands 31. The four sub-commands 31 cooperate to set address and data to a register of the image module 4 for implementing the control command. Each sub-command 31 is a data block and carried by a SPP data packet. The sub-commands 31 are transmitted in sequence at an interval of 1 ms, in another hand, the image module 4 will processes the sub-command 31 and return a corresponding ACK 41 to the host 3. When completely sends all four sub-commands 31 out, the host 3 checks the feed-back ACKs 41. If the feed-back ACKs 41 are faultless, then continue to send another control command, or else resends the sub-commands 31 of the control command in sequence.

Each data packet transmitted with Bluetooth SPP wireless connection delays for about 20 ms under baud rate 921.6 Kpbs. The sub-command 31 is sent one by one at an interval of 1 ms. Therefore, successfully transmitting a control command which includes four sub-commands 31 costs 43 ms. That is much better than 160 ms in the prior art under same condition.

At the startup process of the image module 4, the host 3 sends a lot of control commands to initialize the image module 4, in another hand, at the normal working state, the host 3 sends control commands to command the image module 4 to capture image and send image to the host 3 over and over again. As the host 3 checks the feed-back ACKs 41 after completely sending all the sub-commands 31 out, the host 3 no longer wastes time on waiting an ACK 41 before sending another sub-command 31. The delay of transmitting a control command has been cut down. As a result, it cuts delay down and improves transmitting efficiency of the wireless communication system.

Thus, specific embodiments and applications of method for transmitting real time image data of wireless communication system have been disclosed. It should be apparent, however, to those skilled in the art that many more modifications besides those already described are possible without departing from the inventive concepts herein. The inventive subject matter, therefore, is not to be restricted except in the spirit of the appended claims. Moreover, in interpreting both the specification and the claims, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced. Where the specification claims refer to at least one of something selected from the group consisting of A, B, C . . . and N, the text should be interpreted as requiring only one element from the group, not A plus N, or B plus N, etc.

What is claimed is:

1. A method for transmitting real time image data of wireless communication system, said image data transmitted from an image module to a host, said host controlling said image module to capture image and send image module data back to said host upon the correspondence of control command, the control command having a plurality of sub-commands for the correspondence, the process for transmitting said control command from said host to said image module comprising the steps of:
a. transmitting said sub-commands of said control command from said host to said image module in sequence;
b. processing said sub-commands received and returning an acknowledgement to said host by said image module;
c. when completely sending out all sub-commands, checking said acknowledgements received by said host, if said acknowledgements represents fault, then resending the sub-commands of said control command in sequence.

2. The method for transmitting real time image data of wireless communication system as claimed in claim 1, wherein said host and said image module establishes wireless communication by Bluetooth SPP technology.

3. The method for transmitting real time image data of wireless communication system as claimed in claim 1, wherein said host installs a control program for initializing and controlling said image module.

4. The method for transmitting real time image data of wireless communication system as claimed in claim 1, wherein said sub-command is carried by a data packet.

5. The method for transmitting real time image data of wireless communication system as claimed in claim 1, wherein said host is an electronic device.
